(19) United States
(12) Patent Application Publication
(10) Pub. No.: US 2025/0017168 A1
(43) Pub. Date: Jan. 16, 2025

(54) Pet Carrier Device And Method Of Use

(71) Applicant: Kathy Jo Guajaca, Denver, CO (US)

(72) Inventor: Kathy Jo Guajaca, Denver, CO (US)

(21) Appl. No.: 18/222,129

(22) Filed: Jul. 14, 2023

(51) Int. Cl. A01K 1/02

(52) U.S. Cl. CPC A01K 1/0245

(57) ABSTRACT

A pet carrier enabling physical interaction with a confined pet includes a housing, which defines an interior space and which comprises a sidewall that is attached to and which extends between a bottom panel and a top panel. The bottom panel is substantially rigid. A pet is insertable through a cutout in the housing into the interior space. A sleeve is attached by a first end to the housing and extends from an aperture in the sidewall. A second end the sleeve allows for insertion of a hand of a user, thereby enabling the user to physically interact with the pet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pet carriers and more particularly pertains to a new pet carrier enabling physical interaction with a confined pet by insertion of a hand into the pet carrier, thereby allowing a user to pet, scratch, or stroke the pet.

### (2) Description of Related Art Including Information Disclosed Under 37 CFR 1.97 and 1.98

The prior art relates to pet carriers with access openings allowing for physical interaction with pets confined within the pet carriers but which do not allow for the pets to escape the carriers through the access openings.

### BRIEF SUMMARY OF THE INVENTION

An embodiment of the disclosure meets the needs presented above by generally comprising a housing, which defines an interior space and which comprises a sidewall that is attached to and which extends between a bottom panel and a top panel. The bottom panel is substantially rigid. The housing is configured to house a pet that is inserted through a cutout in the housing into the interior space. A sleeve is attached by a first end to the housing and extends from an aperture in the sidewall. A second end of the sleeve is configured for insertion of a hand of a user, thereby allowing the user to physically interact with the pet.

Another embodiment of the disclosure includes a method of physically interacting with a pet in a pet carrier. The method entails provision of a pet carrier device, according to the disclosure above. Steps of the method include inserting the pet through the cutout into the interior space, inserting a hand through the sleeve, and interacting physically with the pet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a sleeve stowed isometric perspective view of a pet carrier device according to an embodiment of the disclosure.

FIG. 2 is a sleeve folded isometric perspective view of an embodiment of the disclosure.

FIG. 3 is a sleeve extended isometric perspective view of an embodiment of the disclosure.

FIG. 4 is a sleeve open isometric perspective view of an embodiment of the disclosure.

FIG. 5 is a side view of an embodiment of the disclosure.

FIG. 6 is a cross-sectional view of an embodiment of the disclosure.

FIG. 7 is an in-use view of an embodiment of the disclosure.

FIG. 8 is a flow diagram for a method utilizing an embodiment of the disclosure.

### DETAILED DESCRIPTION OF THE INVENTION

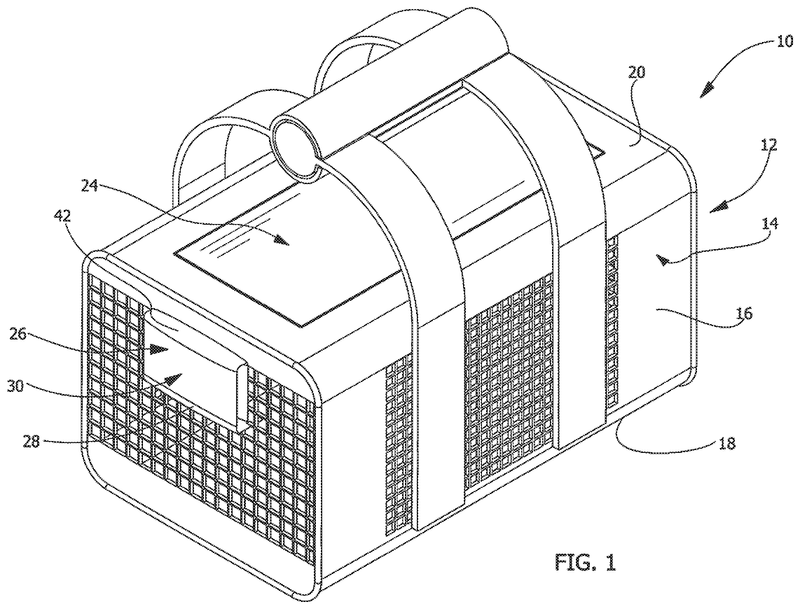

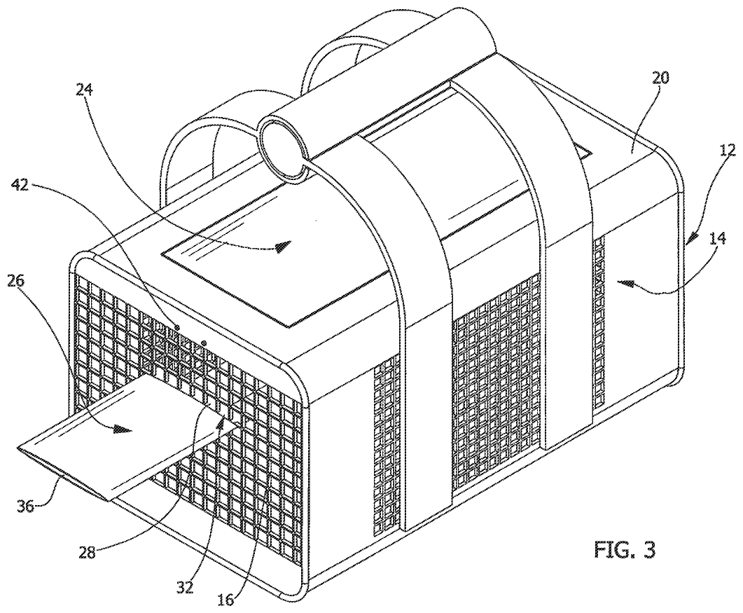

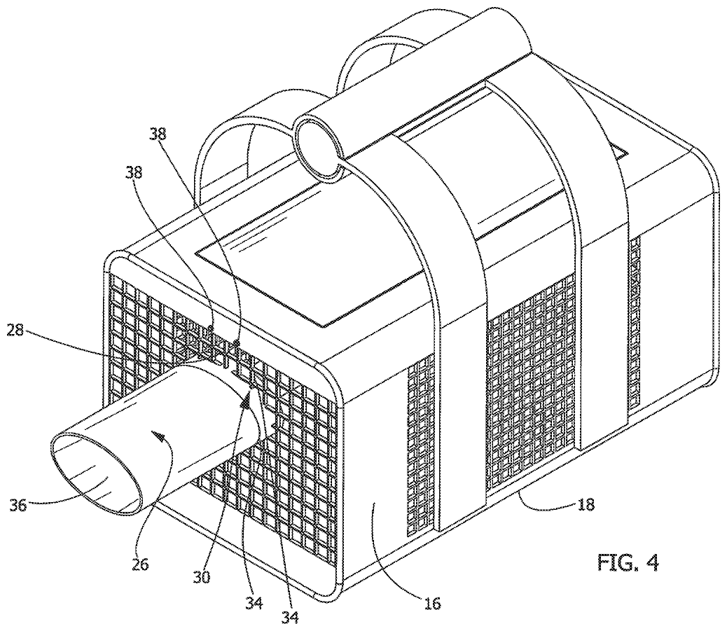

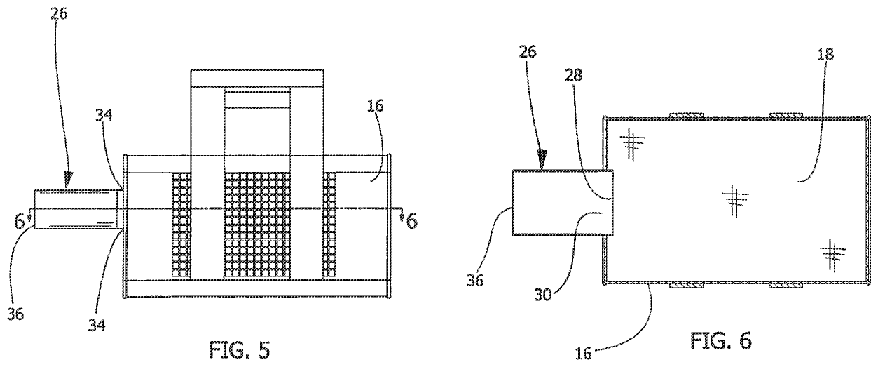

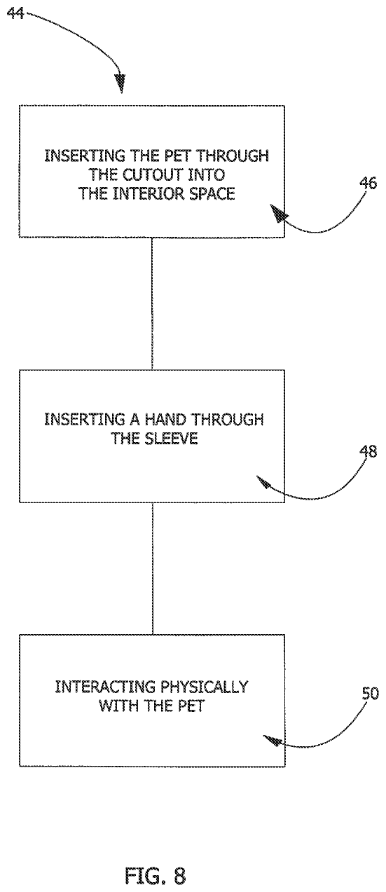

With reference now to the drawings, and in particular to FIGS. 1 through 8 thereof, a new pet carrier device embodying the principles and concepts of an embodiment of the disclosure and generally designated by the reference numeral 10 will be described.

As best illustrated in FIGS. 1 through 8, the pet carrier device 10 generally comprises a housing 12, which defines an interior space 14 and which comprises a sidewall 16 that is attached to and which extends between a bottom panel 18 and a top panel 20. The bottom panel 18 is substantially rigid. The housing 12 is configured to house a pet 22 that is inserted through a cutout 24 in the housing 12 into the interior space 14. Such housings 12 for pets 22 are well known to those skilled in the art of pet carriers. Pet carriers are available in a variety of sizes, shapes, and materials, which may be rigid or flexible. By way of example for this specification, FIGS. 1-7 depict a housing 12 that comprises flexible mesh portions and upper handles and which is sized to house a small dog that is positioned in the housing through a cutout 24 in the top panel 20.

A sleeve 26 is attached by a first end 28 to the housing 12 and extends from an aperture 30 in the sidewall 16. The sleeve 26 also could extend from an aperture 30 in the top panel 20. The sleeve 26 comprises fabric, such as, but not limited to blended polyamide and polyether-polyurea copolymer, wool, cotton, or the like. The aperture 30 in FIGS. 1-7 comprises a slit 32 in the sidewall 16, with the sidewall 16 being comprised of resiliently flexible material so that opposed edges 34 of the slit 32 separate as the hand of the user is inserted into the sleeve 26. For a housing 12 wherein the sidewall 16 is rigid (not shown), the sleeve 26 would extend from an opening in the sidewall 16, with the opening being oval, circular, or the like.

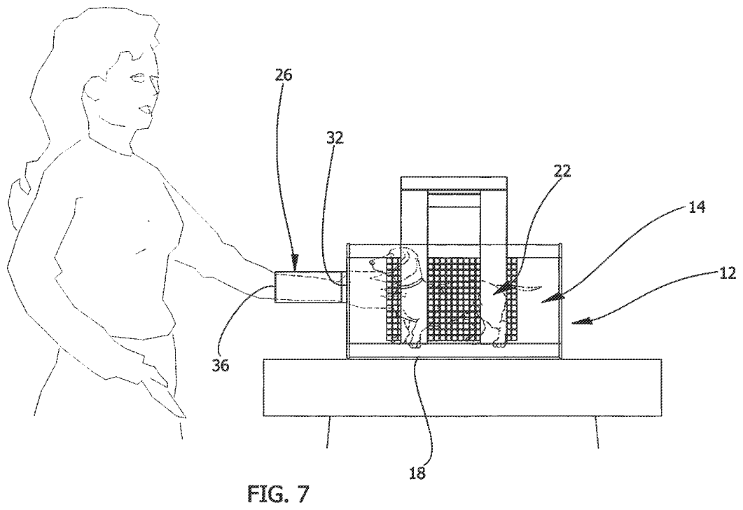

A second end 36 of the sleeve 26 is configured for insertion of a hand of a user, thereby allowing the user to physically interact with the pet 22, as is shown in FIG. 7. A pet 22 may become excited or agitated if the user attempts to interact with the pet 22 by partially opening the cutout 24, as the pet 22 associates opening of the cutout 24 with removal from the housing 12. Additionally, the cutout 24 is typically closed by means of a zipper, which can cause discomfort to the user by scrapping against the wrist and forearm of the user. Physical interaction with a pet 22 confined in a pet carrier is desirable for several reasons, such as to provide comfort to the pet 22 in a stressful situation, such as when traveling, or to provide comfort to the user, such as may be the case with a user who is accompanied by an emotional support animal. The pet carrier device 10 also may be beneficial in containing and accessing a pet 22 for examination by a veterinarian.

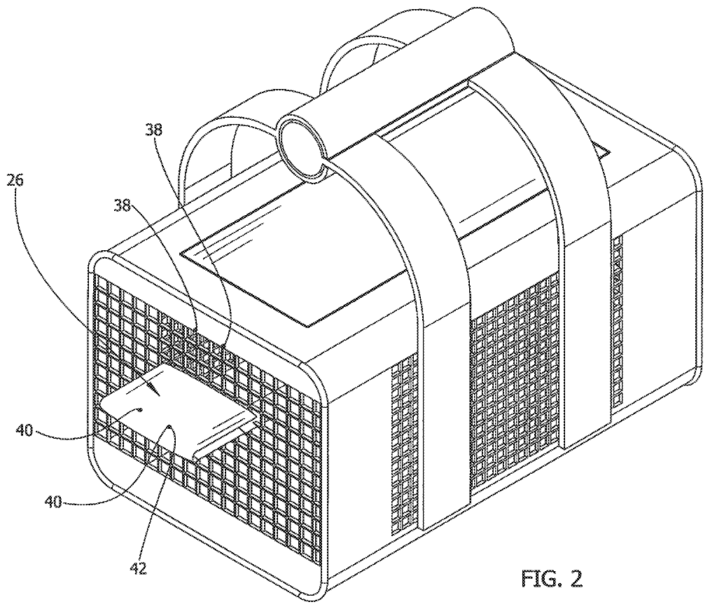

A set of first fasteners 38 is attached to the housing 12 and a set of second fasteners 40 is attached to the sleeve 26. The second fasteners 40 are complementary to the first fasteners 38 so that each second fastener 40 is positioned for selective attachment to an associated first fastener 38. The second fastener 40 and the associated first fastener 38 may comprise a snap closure 42, or other fastening means, such as, but not limited to, hook and loop closures, magnets, or the like. As is shown in FIG. 2, the first fasteners 38 are positioned on the sidewall 16 above the aperture 30 and the second fasteners 40 are positioned substantially equidistant from the first end 28 and the second end 36 of the sleeve 26. The sleeve 26 thus is foldable proximate to the second fasteners 40, positioning the user to attach the second fasteners 40 to the first fasteners 38 to stow the sleeve 26 in a covering position over the aperture 30, as is shown in FIG. 1. Attaching the sleeve 26 to the housing 12 renders it more difficult for the pet 22 to pull the sleeve 26 into the interior space 14 and therefore limits potential for the pet 22 to chew on the sleeve 26.

In use, the pet carrier device 10 enables a method of physically interacting with a pet in a pet carrier 44. The method 44 comprises providing a pet carrier device 10, according to the specification above. A first step 46 of the method 44 is inserting the pet 22 through the cutout 24 into the interior space 14. A second step 48 of the method 44 is inserting a hand through the sleeve 26. A third step 50 of the method 44 is interacting physically with the pet 22, such as by petting, scratching, or stroking the pet 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pet carrier device comprising:
a housing defining an interior space and comprising:
a bottom panel, the bottom panel being substantially rigid;
a top panel; and
a sidewall attached to and extending between the bottom panel and the top panel, wherein the housing is configured to house a pet inserted through a cutout in the housing into the interior space;
a sleeve attached by a first end to the housing and extending from an aperture in the sidewall, wherein a second end of the sleeve is configured for insertion of a hand of a user, allowing the user to physically interact with the pet;
a set of first fasteners attached to the housing;
a set of second fasteners attached to the sleeve, the second fasteners being complementary to the first fasteners, such that each second fastener of the set of second fasteners is positioned for selective attachment to an associated first fastener of the set of first fasteners;
the first fasteners of the set of first fasteners are positioned on the sidewall above the aperture; and
the second fasteners of the set of second fasteners are positioned substantially equidistant from the first end and the second end of the sleeve, such that the sleeve is foldable proximate to the second fasteners for attaching the second fasteners to the first fasteners to stow the sleeve in a closed position of the sleeve and covering position over the aperture.

2. The pet carrier device of claim 1, wherein the aperture comprises a slit in the sidewall, the sidewall being comprised of resiliently flexible material, such that opposed edges of the slit separate as the hand of the user is inserted into the sleeve.

3. The pet carrier device of claim 1, wherein the sleeve comprises fabric.

4. The pet carrier device of claim 3, wherein the sleeve comprises blended polyamide and polyether-polyurea copolymer.

5. (canceled)

6. The pet carrier device of claim 1, wherein the second fastener and the associated first fastener comprise a snap closure.

7. (canceled)

8. A pet carrier device comprising:
a housing defining an interior space and comprising:
a bottom panel, the bottom panel being substantially rigid;
a top panel; and
a sidewall attached to and extending between the bottom panel and the top panel, wherein the housing is configured to house a pet inserted through a cutout in the housing into the interior space;
a sleeve attached by a first to the housing and extending from an aperture in the sidewall, wherein a second end the sleeve is configured for insertion of a hand of a user, allowing the user to physically interact with the pet, the aperture comprising a slit in the sidewall, the sidewall being comprised of resiliently flexible material, such that opposed edges of the slit separate as the hand of the user is inserted into the sleeve, the sleeve comprising fabric, the sleeve comprising blended polyamide and polyether-polyurea copolymer;
a set of first fasteners attached to the housing; and
a set of second fasteners attached to the sleeve, the second fasteners being complementary to the first fasteners, such that each second fastener of the set of second fasteners is positioned for selective attachment to an associated first fastener of the set of first fasteners, the second fastener and the associated first fastener comprising a snap closure, the first fasteners of the set of first fasteners being positioned on the sidewall above the aperture, the second fasteners of the set of second fasteners being positioned substantially equidistant from the first end and the second end of the sleeve, such that the sleeve is foldable proximate to the second fasteners for attaching the second fasteners to the first fasteners to stow the sleeve in a closed position of the sleeve and covering position over the aperture.

9. A method of physically interacting with a pet in a pet carrier, the method comprising providing the pet carrier device of claim 1, and:
inserting the pet through the cutout into the interior space;
inserting the hand through the sleeve; and
interacting physically with the pet.
